(19) United States
(12) Patent Application Publication
(10) Pub. No.: US 2025/0073679 A1
(43) Pub. Date: Mar. 6, 2025

(54) ADSORBENT WITH HIERARCHICAL STRUCTURE

(71) Applicant: L'Air Liquide, Societe Anonyme pour l'Etude et l’Exploitation des Procedes Georges Claude, Paris (FR)

(72) Inventors: Federico BRANDANI, Jouy-en-Josas (FR); Pluton PULLUMBI, Jouy-en-Josas (FR)

(73) Assignee: L'Air Liquide, Societe Anonyme pour l'Etude et l’Exploitation des Procedes Georges Claude, Paris (FR)

(21) Appl. No.: 18/817,820

(22) Filed: Aug. 28, 2024

(30) Foreign Application Priority Data
Aug. 29, 2023 (FR) FR 2309047

(51) Int. Cl. B01J 20/30; B01D 53/02; B01J 20/18

(52) U.S. Cl. CPC B01J 20/3028; B01D 53/02; B01J 20/183; B01D 2253/108; B01D 2258/06

(57) ABSTRACT

Adsorbent agglomerate having an inner region and a superposition of layers of adsorbent particles, the layers of adsorbent particles succeeding each other starting from the inner region, enveloping the inner region, each of the adsorbent particles having a volume termed particle volume, at least two layers of adsorbent particles constituting mutually hierarchical layers, the at least two layers being the layers of adsorbent particles furthest from the inner region, in which adsorbent agglomerate the adsorbent particles constituting each of the hierarchical layers preceding a following hierarchical layer succeeding it have an average particle volume less than the average particle volume of the adsorbent particles constituting the following hierarchical layer, a standard deviation of the particle volume values of the adsorbent particles of each of the hierarchical layers being less than 20%, preferably less than 5% relative to the average particle volume of the adsorbent particles constituting the hierarchical layer.

### CROSS-REFERENCE TO RELATED APPLICATIONS

This application claims the benefit of priority under 35 U.S.C. § 119 (a) and (b) to French patent application No. FR 2309047, filed Aug. 29, 2023, the entire contents of which are incorporated herein by reference.

### BACKGROUND

The invention resides in the field of materials for separating gas mixtures into a high-adsorbability fraction and a low-adsorbability fraction.

### RELATED ART

Adsorption is widely used to purify or separate (fractionate) gases. Instances include the fractionation of “n” and “iso” paraffins, fractionation of xylenes, of alcohols, production of nitrogen or oxygen from atmospheric air, and removal of CO2 from flue gases and from blast furnace gases. On the purification side, there are dryers, hydrogen or helium purging, methane-rich gas purging, adsorption of trace impurities in numerous fluids (stopping mercury, NOx, sulfur products, etc.).

Increasing the efficiency and reducing the costs of adsorptive separation processes involves improving the adsorbents used in such processes and reducing the cycle times. The need for reduced mass transfer zones in rapid adsorption cycles requires the use of smaller-sized adsorbent agglomerates or smaller-sized non-agglomerated adsorbent solids or crystals. However, reducing the size of the adsorbents leads to an increase in the pressure drops through the adsorbent bed and leads to a risk of fluidization of said bed. Since the smaller-sized adsorbents are also more fragile, their deterioration during handling operations or by fluidization is probable.

It is therefore desirable to propose an adsorbent that alleviates these known drawbacks of the prior art.

### SUMMARY OF THE INVENTION

The invention therefore relates to an adsorbent agglomerate comprising an inner region and a superposition of layers of adsorbent particles, the layers of adsorbent particles succeeding each other starting from said inner region, enveloping said inner region, each of the adsorbent particles having a volume termed particle volume, at least two layers of adsorbent particles constituting mutually hierarchical layers, said at least two layers being the layers of adsorbent particles furthest from the inner region, in which adsorbent agglomerate the adsorbent particles constituting each of said hierarchical layers preceding a following hierarchical layer succeeding it have an average particle volume less than the average particle volume of the adsorbent particles constituting the following hierarchical layer, a standard deviation of the particle volume values of the adsorbent particles of each of the hierarchical layers being less than 20%, preferably less than 10%, preferably less than 5% relative to the average particle volume of the adsorbent particles constituting the hierarchical layer under consideration.

According to one embodiment, the hierarchical layers are concentric. More particularly, the inner region is a central region of the adsorbent agglomerate.

According to one embodiment, the adsorbent agglomerate comprises at least three hierarchical layers, preferably at least four hierarchical layers.

According to one embodiment, the adsorbent agglomerate comprises between two and fifteen hierarchical layers, endpoints included, preferably between two and ten hierarchical layers, endpoints included.

According to one embodiment, the thickness of each of the hierarchical layers is between 30 and 500 microns. More particularly, the thickness of a hierarchical layer furthest from the inner region is between 30 and 300 microns. More particularly, the thickness of the hierarchical layer preceding the following hierarchical layer furthest from the inner region is between 50 and 400 microns. More particularly, the thickness of the hierarchical layer preceding the following hierarchical layer which itself precedes the hierarchical layer furthest from the inner region is between 100 and 500 microns. More particularly, the hierarchical layer furthest from the inner region, the hierarchical layer preceding the following hierarchical layer furthest from the inner region, and the hierarchical layer preceding the following hierarchical layer which itself precedes the hierarchical layer furthest from the inner region have the same or substantially the same volume.

According to one embodiment, the ratio of the volume of each of the hierarchical layers following a preceding hierarchical layer to the volume of said preceding hierarchical layer is between 100% and 350%, preferably between 150% and 250%. More particularly, the ratio of the volume of a hierarchical layer furthest from the inner region to the volume of a hierarchical layer preceding the following hierarchical layer furthest from the inner region is between 170% and 250%. More particularly, the ratio of the volume of the hierarchical layer preceding the following hierarchical layer furthest from the inner region to the volume of a hierarchical layer preceding the following hierarchical layer which itself precedes the following hierarchical layer furthest from the inner region is between 190% and 220%.

According to one embodiment, the ratio of the volume of a hierarchical layer furthest from the inner region to the volume of the adsorbent agglomerate is between 20% and 90%, preferably between 35% and 75%, preferably between 45% and 65%.

The inter-particle spaces of the outermost hierarchical layer or layers covering the preceding hierarchical layer or layers are advantageously wider than the inter-particle spaces of the preceding hierarchical layer or layers.

According to one embodiment, the hierarchical layers represent at least 30%, preferably at least 50%, preferably at least 60% of the entirety of the layers of the adsorbent agglomerate. The average volume of adsorbent particles increases continuously between a hierarchical layer closest to the inner region and a hierarchical layer furthest from the inner region. The hierarchical layer furthest from the inner region is not covered by any other layer of adsorbent particles.

According to one embodiment, the inner region comprises an aggregate of adsorbent particles. More particularly, no layer hierarchy of adsorbent particles is present in the aggregate.

According to one embodiment, the adsorbent agglomerate is substantially spherical.

According to one embodiment, the particle volume of each of the adsorbent particles comprised in the hierarchical layers is between 4 and 4000 micron³, preferably between 40 and 400 micron³. More particularly, the particle volume of each of the adsorbent particles of a hierarchical layer furthest from the inner region is between 200 and 4000 micron³. More particularly, the particle volume of each of the adsorbent particles of a hierarchical layer preceding the following hierarchical layer furthest from the inner region is between 60 and 1000 micron³. More particularly, the particle volume of each of the adsorbent particles of a hierarchical layer preceding the following hierarchical layer which itself precedes the following hierarchical layer furthest from the inner region is between 30 and 500 micron³.

According to one embodiment, the adsorbent particles are substantially spherical and the adsorbent particles constituting each of said hierarchical layers preceding a following hierarchical layer succeeding it have an average diameter smaller than the average diameter of the adsorbent particles constituting said following hierarchical layer.

According to one embodiment, the adsorbent particles comprise one or more adsorbent crystals. More particularly, the adsorbent particles comprise a plurality of adsorbent crystals agglomerated together. In a particular embodiment, each adsorbent particle comprised in the hierarchical layers consists of a single adsorbent crystal. In this embodiment, the adsorbent crystals constituting each of said hierarchical layers preceding a following hierarchical layer succeeding it have an average volume less than the average volume of the adsorbent crystals constituting said following hierarchical layer.

According to one embodiment, the adsorbent particles comprised in the hierarchical layers comprise one or more amorphous solids. More particularly, the adsorbent particles comprise a plurality of agglomerated amorphous solids. Amorphous solids comprise in particular an activated carbon, alumina or other metal oxides and/or silica, such as a silica gel. In a particular embodiment, each adsorbent particle comprised in the hierarchical layers consists of a single amorphous solid. In this embodiment, the amorphous solids constituting each of said hierarchical layers preceding a following hierarchical layer succeeding it have an average volume less than the average volume of the amorphous solids constituting said following hierarchical layer.

According to one embodiment, the adsorbent particles comprise a binder, more particularly between 1 and 12 weight percent (wt %) of binder, preferably between 4 and 10 weight percent of binder.

According to one embodiment, the adsorbent agglomerate comprises a binder between the adsorbent particles, more particularly between 1 and 10 weight percent (wt %) of binder.

According to one embodiment, the adsorbent agglomerate is a zeolite adsorbent, in particular an FAU zeolite, in particular an X, Y or A zeolite, more particularly exchanged with calcium. Preferably, the adsorbent agglomerate is a zeolite of the LSX type.

According to one embodiment, the adsorbent agglomerate has a tortuosity of between 1 and 2.2.

Another subject of the invention is an adsorber comprising an adsorbent bed, said bed comprising a plurality of adsorbent agglomerates as described above.

Another subject of the invention is a process for adsorptive separation of a gas mixture, using an adsorbent agglomerate as described above or an adsorber as described above. The process is in particular a pressure swing adsorption (PSA) process, more particularly a VSA or VPSA process. The process can also be an RPSA (rapid PSA) pressure swing adsorption process, in which the duration of the pressure cycle is typically less than a minute. The process is in particular an air separation process, for example for the production of oxygen.

Another subject of the invention is the use of the adsorbent agglomerate as described above or of an adsorber as described above in processes for fractionating “n” and “iso” paraffins, fractionating xylenes, fractionating alcohols, or processes for purging hydrogen or helium.

Another subject of the invention is a process for manufacturing an adsorbent agglomerate, in particular as described above, comprising the following steps:
supplying a plurality of adsorbent particles, each of the adsorbent particles having a volume termed particle volume,
forming at least two batches of adsorbent particles, each batch of adsorbent particles corresponding to a targeted average particle volume of the particles constituting it, a standard deviation of the particle volume values of the adsorbent particles of each batch being less than 20%, preferably less than 10%, preferably less than 5% relative to the targeted average particle volume of said batch,
an agglomeration step comprising the sub-steps of:
a) agglomerating adsorbent particles of a first batch into a first layer of adsorbent particles,
b) agglomerating adsorbent particles of the following batch into a following upper layer of adsorbent particles, covering the first layer of adsorbent particles,
the targeted average particle volume of each of the batches preceding a following batch being less than the targeted average particle volume of said following batch.

In one embodiment, step b) is repeated until the adsorbent particles of a last batch are agglomerated into a last layer of adsorbent particles covering the preceding layer of adsorbent particles. The adsorbent agglomerate then comprises at least three layers of adsorbent particles.

According to one embodiment, the number of batches is between two and fifteen, endpoints included, in particular between two and ten, endpoints included.

According to one embodiment, the particle volume of the adsorbent particles supplied is between 4 and 4000 micron³, preferably between 40 and 400 micron³. More particularly, the particle volume of the adsorbent particles of the first batch is between 4 and 10 micron³. More particularly, the particle volume of the adsorbent particles of the last batch is between 200 and 4000 micron³. More particularly, the particle volume of the adsorbent particles of the batch preceding the last batch is between 60 and 1000 micron³.

According to one embodiment, the process comprises a step of supplying an aggregate of adsorbent particles, and agglomeration (agglomeration step) of the adsorbent particles of the batches formed takes place on the aggregate. More particularly, no layer hierarchy of adsorbent particles is present in the aggregate.

According to one embodiment, the batches are formed by sieving the adsorbent particles.

According to one embodiment, the process comprises a step of feeding adsorbent particles of the batches formed to the agglomeration step, the feeding taking place from reservoirs of adsorbent particles, each reservoir containing one of the batches formed.

According to one embodiment, the agglomeration step takes place in the presence of moisture or dry.

According to one embodiment, the agglomeration step comprises a sub-step of preparing each of the batches of adsorbent particles in the form of a dispersion of adsorbent particles. The dispersion comprises, in particular, a surfactant and a pore-forming agent.

According to one embodiment, the agglomeration step takes place by fluidization.

More particularly, the agglomeration step comprises the sub-steps of:
a′) fluidized bed spraying of a first prepared dispersion, corresponding to the first batch, until the adsorbent particles of the first dispersion agglomerate into a first layer of adsorbent particles,
b′) fluidized bed spraying of a following prepared dispersion, corresponding to the following batch, until the adsorbent particles of the following dispersion agglomerate into a following layer of adsorbent particles covering the first layer of adsorbent particles.

According to one embodiment, step b′) is repeated until the agglomeration of the adsorbent particles of a last dispersion, corresponding to the last batch, into a last layer of adsorbent particles covering the preceding layer of adsorbent particles.

According to one embodiment, the fluidized bed agglomeration step is carried out in a reactor in which the dispersions prepared are fed as spray, in particular at a pressure of between 1 and 10 bar absolute. The pressure within the reactor is in particular between 1 and 10 bar absolute.

According to one embodiment, fluidization is carried out by circulating a gas stream in the reactor, said gas stream being in particular at a temperature of between 4° and 500° C.

Alternatively, the agglomeration step is done by turntable. More particularly, the agglomeration step comprises the sub-steps of:
a″) placing on a tray a first prepared dispersion, corresponding to the first batch, and rotating said tray until the adsorbent particles of the first dispersion agglomerate into a first layer of adsorbent particles,
a1″) optionally transferring the agglomerated adsorbent particles from said tray to another tray,
b″) placing on said tray or other tray a following prepared dispersion, corresponding to the following batch, and rotating said tray or other tray until the adsorbent particles of the following dispersion agglomerate into a following adsorbent particle layer covering the first layer of adsorbent particles.

All the dispersions may be agglomerated on the same tray. Alternatively, the dispersions are each agglomerated on a different tray. The agglomeration step then comprises the transfer sub-step a1″).

According to one embodiment, step b″) and optionally step a1″) is repeated up to and including the agglomeration of the adsorbent particles of a last dispersion, corresponding to the last batch, into a last layer covering the preceding layer.

According to one embodiment, the process comprises a step of discharge and a step of activation of the adsorbent agglomerate obtained.

### BRIEF DESCRIPTION OF THE FIGURES

FIG. 1 represents an adsorbent agglomerate according to the invention;

FIG. 2 represents a first embodiment of a process for manufacturing an adsorbent agglomerate;

FIGS. 3 and 4 each represent a variant of a second embodiment of the manufacturing process.

### DETAILED DESCRIPTION OF THE INVENTION

An adsorbent agglomerate comprises an inner region 7 and a superposition of layers of adsorbent particles 1, the layers of adsorbent particles succeeding each other starting from said inner region 7, enveloping said inner region 7, each of the adsorbent particles 1 having a volume termed particle volume, at least two layers 2, 3, 4, 5 of adsorbent particles 1 constituting mutually hierarchical layers, each of the hierarchical layers consisting of a set of adsorbent particles 1 having a targeted average particle volume, a standard deviation of the particle volume values of the adsorbent particles 1 of each of the sets being less than 20%, preferably less than 10%, preferably less than 5% relative to the targeted average particle volume of said set of adsorbent particles 1, said at least two layers 2, 3, 4, 5 being the furthest layers from the inner region 7, characterized in that in each of the hierarchical layers 2, 3, 4 covered by a following hierarchical layer 3, 4, 5 succeeding it, the targeted average particle volume is less than the targeted average particle volume of the set of adsorbent particles 1 constituting the following hierarchical layer 3, 4, 5.

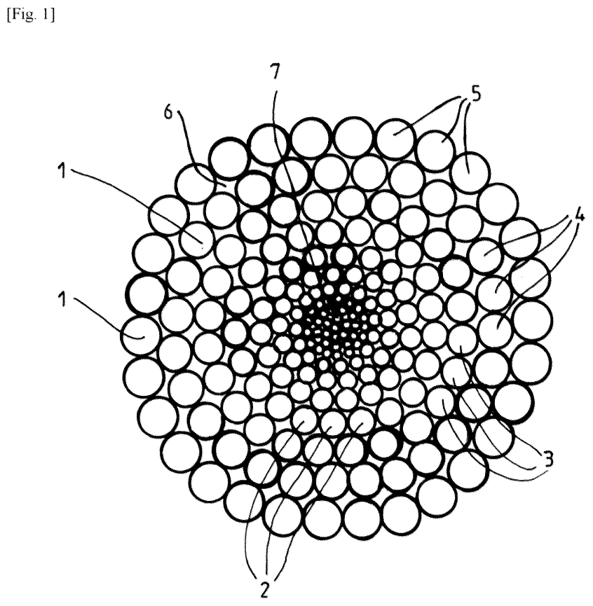

The adsorbent agglomerate according to the invention comprises substantially spherical adsorbent particles 1 arranged in layers and an inner region 7, here a central region of the adsorbent agglomerate. In the embodiment of FIG. 1, a layer 2 of adsorbent particles is covered by an upper following layer 3 covering the lower layer 2, which is itself covered by an upper following layer 4 covering the lower layer 3, which is itself covered by an upper following layer 5 covering the lower layer 4. The layers 2, 3, 4 and 5 have a distance from the inner region 7 and are the layers furthest from the inner region 7. The layer 5 is the layer furthest from the inner region 7, or the outermost layer, of the adsorbent agglomerate. The layers 2, 3, 4 and 5 envelop the inner region 7. The layers 2, 3, 4 and 5 follow one another starting from said inner region 7, that is to say, in the direction from the inner region towards an outer surface of the adsorbing agglomerate, the layer 2 precedes the layer 3, which precedes the layer 4 which itself precedes the layer 5 furthest from the internal region 7. In other words, the layer 5 succeeds the layer 4, which itself succeeds the layer 3, which itself succeeds the layer 2.

In the sense of the invention, a layer immediately preceding another is called a “preceding layer” and a layer immediately succeeding another is called a “following layer”.

The adsorbent agglomerate of FIG. 1 thus comprises a superposition of concentric layers 2, 3, 4 and 5 of adsorbent particles 1, each of the adsorbent particles 1 having a volume termed particle volume. Each of the layers 2, 3, 4 and 5 corresponds to a targeted average particle volume of each of the adsorbent particles 1 comprised therein, namely that the adsorbent particles 1 comprised in one of the layers 2, 3, 4 and 5 each have a particle volume close to the targeted average particle volume, the particle volume being able to vary between the adsorbent particles 1 with a standard deviation of the particle volume values of the particles 1 of said layer, which controlled standard deviation is less than 20%, preferably less than 10%, preferably less than 5% relative to the targeted average particle volume of said layer. The layer is thus defined by the volume of the adsorbent particles 1 which constitute it. The targeted average particle volume corresponds to the desired volume value for the design of a layer.

The layers 2, 3, 4 and 5 constitute so-called hierarchical layers. The hierarchical layers 2, 3, 4, 5 have a hierarchy between them by obeying the following rule: the targeted average particle volume of the adsorbent particles 1 of a hierarchical layer 2, 3, 4 termed the lower layer is strictly less than the targeted average particle volume of the adsorbent particles of the following hierarchical layer 3, 4, 5 succeeding the lower layer 2, 3, 4, the following hierarchical layer 3, 4, 5 covering said lower layer 2, 3, 4.

The average particle volume of a hierarchical layer is calculated by the sum of the volumes of the entirety of the adsorbent particles in the hierarchical layer, divided by the number of adsorbent particles in said hierarchical layer. The standard deviation of the particle volumes of the particles in a hierarchical layer corresponds to the spread of particle volume values of particles in said hierarchical layer around the targeted average particle volume of said hierarchical layer.

In the embodiment of FIG. 1, the inner region 7 is constituted by an aggregate of adsorbent particles in layers having no particular hierarchy between them. The layers 2, 3, 4 and 5 are arranged around the aggregate, enveloping it.

The agglomeration of the adsorbent particles with one another is optionally done using a binder.

In the embodiment shown, the adsorbent particles 1 are formed by a powder of crystals, the powder being agglomerated in order to form said adsorbent particles.

Agglomeration there too can take place using a binder. In another embodiment (not shown), the adsorbent particles are formed by a powder of amorphous solids, the powder being agglomerated in order to form said adsorbent particles. The amorphous solids can consist of an activated carbon or a silica gel. Agglomeration can here again take place using a binder.

Adsorbent particles 1 comprising agglomerated amorphous solids or crystals, when they are substantially spherical, are also called adsorbent beads. The adsorbent agglomerate with hierarchical porosity according to the invention then comprises an agglomeration of adsorbent beads arranged in concentric layers, each of said beads comprising an agglomeration of amorphous solids or crystals. In an embodiment where each adsorbent particle within the meaning of the invention consists of a single adsorbent crystal, the adsorbent agglomerate with hierarchical porosity comprises an agglomeration of crystals arranged in layers. The layers are mutually hierarchical, obeying the following rule: the targeted average volume of the crystals of a lower layer is less than the targeted average volume of the crystals of the following layer, covering said lower layer.

The inter-particle spaces 6 of the layer or layers furthest from the inner region 7, covering the lower layer or layers, are advantageously wider than the inter-particle spaces of the lower layer or layers. The inter-particle space measures the space between the adsorbent particles 1. The inter-particle spaces of the outermost layers open out more particularly on the pore network of the adsorbent particles, in particular the mesopores and micropores. Thus, the diffusion rate of molecules between the adsorbent particles of the outermost layers is optimized. Because the outermost layers generally account for the majority of the volume of the adsorbent agglomerate, mass transfer is greatly improved. In the case of concentric hierarchical layers, the mass transfer properties of the adsorbent are homogenized, thanks to the geometry of the adsorbent agglomerate obeying a central symmetry. The smaller particle volume of the lower layers makes it possible to benefit from the higher adsorption rate characteristic of small adsorbent particles and thus from a greater selectivity. By virtue of the high volume of the adsorbent agglomerate according to the invention, relative to the adsorbent particles 1 constituting it, the drawbacks arising from the use of these adsorbent particles 1 of small size known from the prior art, linked to the increase in pressure losses and/or linked to fluidization, are avoided. A compromise between seemingly irreconcilable properties is therefore found.

The particle volume within the meaning of the invention corresponds to the macroscopic volume of an adsorbent particle 1 as it can be observed and measured under a microscope, that is to say including the interstices between the constituent elements of said adsorbent particle, in particular the spaces between the crystals or between the amorphous solids. The volume of the adsorbent agglomerate within the meaning of the invention corresponds to the macroscopic volume of the adsorbent agglomerate, that is to say including the inter-particle spaces 6. The average volume of the adsorbent particles 1 of a lower layer is less than the average volume of the adsorbent particles 1 of the following layer covering said lower layer. In other words, an average characteristic dimension of the adsorbent particles 1 of the lower layer is less than an average characteristic dimension of the adsorbent particles 1 of the following layer.

The adsorbent agglomerate according to the invention may be a zeolite adsorbent, in particular an FAU zeolite, and preferably a zeolite X. For example, the zeolite X has a silica to alumina ratio of less than 1.15, preferably less than 1.1 or substantially equal to 1.0.

In the embodiment of FIG. 1, it is a calcium (Ca)-exchanged faujasite adsorbent, suitable for use after activation in an adsorbent bed of an adsorber for a pressure swing adsorption separation process, of VSA type. However, the adsorbent agglomerate according to the invention can be used in any adsorption process, for example pressure swing adsorption (PSA), more particularly a VSA (vacuum swing adsorption or VPSA) process. The process can also be an RPSA (rapid PSA) pressure swing adsorption process, in which the duration of the pressure cycle is typically less than a minute.

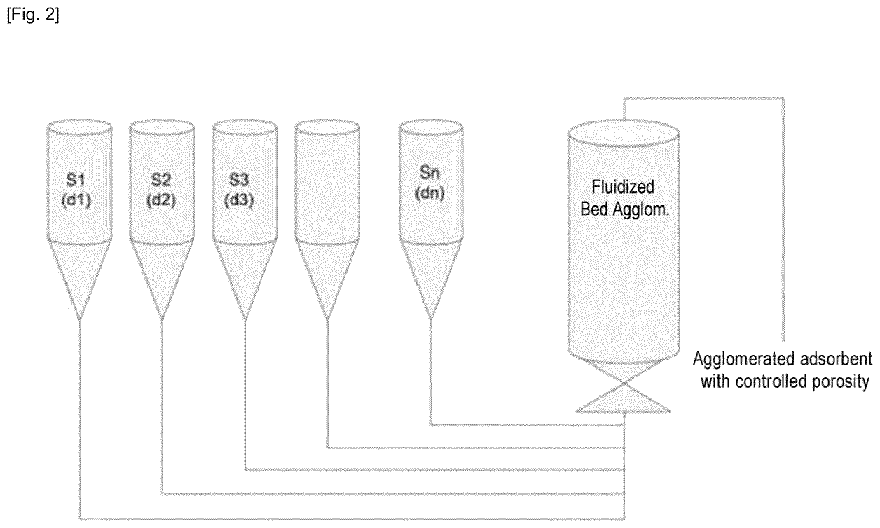

FIG. 2 is a schematic representation of an example of a process for manufacturing, by fluidized bed agglomeration, an adsorbent agglomerate with hierarchical porosity according to the invention.

A quantity of adsorbent particles 1 is supplied, and the adsorbent particles are distributed according to their particle volume, so as to constitute batches S1, S2, S3, . . . Sn. The adsorbent particles 1 comprised in each of the batches S1, S2, S3, . . . Sn all have a similar particle volume which is close to a targeted average particle volume, which characterizes said batch under consideration. The standard deviation of the particle volume values of the adsorbent particles 1 of each of the batches S1, S2, S3, . . . Sn formed is controlled so as to be less than 20%, or even less than 10%, or even less than 5% with respect to the targeted average particle volume. The remainder of the manufacturing process consists of agglomerating the adsorbent particles 1 thus distributed in batches in a hierarchical manner. The batches S1, S2, S3, . . . Sn are classified in this order by increasing average targeted particle volume.

In the example in FIG. 2, the batches S1, S2, S3, . . . Sn are prepared as dispersions d1, d2, d3, . . . , dn with a surfactant and a pore-forming agent. The dispersions d1, d2, d3, . . . , dn prepared in this way are then fed one after the other into a spraying device, for example a fluidization reactor or tank, in which the dispersions d1, d2, d3, . . . , dn are sprayed in a fluidized bed.

The first dispersion d1 is sprayed in a fluidized bed for the time necessary for the adsorbent particles 1 comprised in the first sprayed dispersion d1 to agglomerate together so as to form a first layer 2 of the adsorbent agglomerate. The agglomeration of the first layer 2 can be done on an aggregate. Next, the second dispersion d2 is in turn sprayed in a fluidized bed for the time necessary for the adsorbent particles 1 comprised in the second dispersion d2 to agglomerate into a second layer 3, covering the first layer 2. This continues until the particles of a last dispersion agglomerate into a last layer 5, covering the preceding layer 4. The last layer 5 constitutes the outer layer (or the outermost layer) of the adsorbent agglomerate. An adsorbent agglomerate in concentric layers of adsorbent particles, in which the particle volume decreases steadily from the outer layer to the more inner layers, is thus obtained.

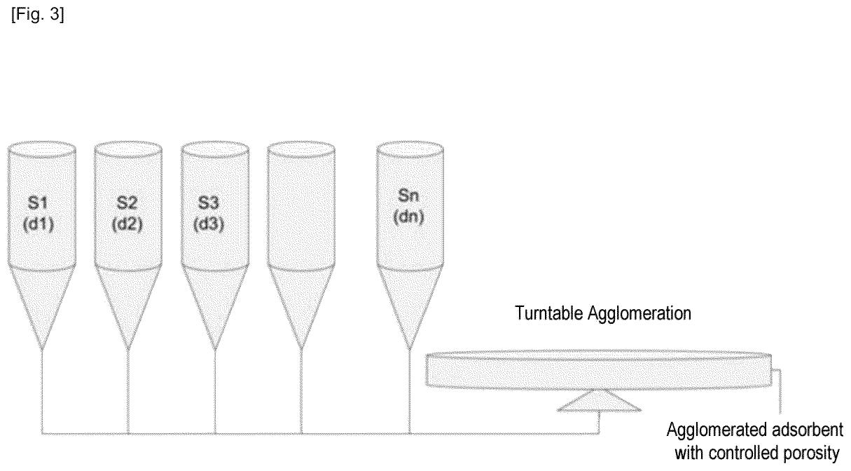

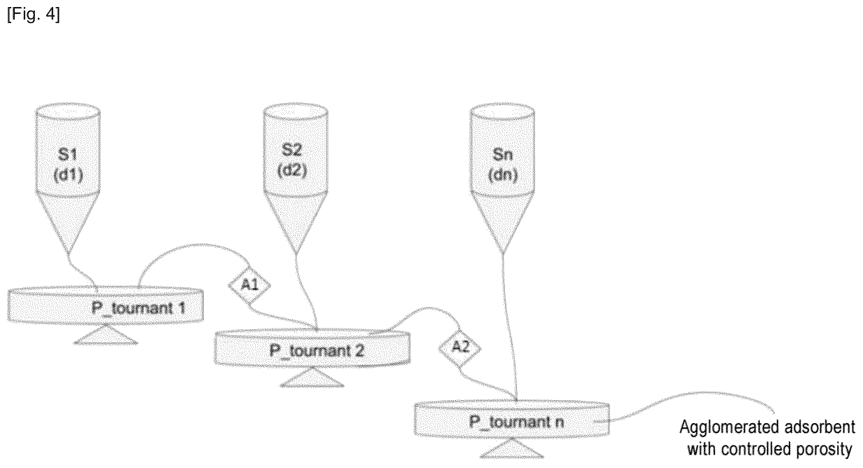

FIG. 3 is a schematic representation of another example of a process for manufacturing an adsorbent agglomerate with hierarchical porosity according to the invention, by turntable agglomeration. The process is similar to that of FIG. 2, but differs in that the dispersions d1, d2, d3, . . . , dn are fed, in the same order, successively one after the other, onto one or more turntables for agglomeration. The turntable or turntables is or are rotated for the time necessary to agglomerate the particles of a given dispersion into a layer, where appropriate covering the preceding layer. All the batches S1, S2, S3, . . . Sn may be agglomerated on one and the same turntable as in the example in FIG. 3, or else each batch S1, S2, S3, . . . Sn may be agglomerated on a different turntable (P_tournant 1, P_tournant 2, . . . P_tournant n), as in the example of FIG. 4, with, if necessary, a step A1, A2 of transferring the adsorbent particles 1 previously agglomerated on a given turntable to the following turntable.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1: An adsorbent agglomerate comprising an inner region and a superposition of layers of adsorbent particles, the layers of adsorbent particles succeeding each other starting from said inner region, enveloping said inner region, each of the adsorbent particles having a volume termed particle volume, at least two layers of adsorbent particles constituting mutually hierarchical layers, said at least two layers being the layers of adsorbent particles furthest from the inner region, in which adsorbent agglomerate the adsorbent particles constituting each of said hierarchical layers preceding a following hierarchical layer succeeding it have an average particle volume less than the average particle volume of the adsorbent particles constituting said following hierarchical layer, a standard deviation of the particle volume values of the adsorbent particles of each of the hierarchical layers being less than 20% relative to the average particle volume of the adsorbent particles constituting said hierarchical layer.

2: The adsorbent agglomerate of claim 1, wherein the hierarchical layers are concentric.

3: The adsorbent agglomerate of claim 1, comprising at least three hierarchical layers.

4: The adsorbent agglomerate of claim 1, wherein the hierarchical layers represent at least 30% of the entirety of layers of the adsorbent agglomerate.

5: The adsorbent agglomerate of claim 1, wherein the inner region comprises an aggregate of adsorbent particles, in which aggregate no layer hierarchy of adsorbent particles is present.

6: The adsorbent agglomerate of claim 1, wherein the adsorbent agglomerate is substantially spherical.

7: The adsorbent agglomerate of claim 1, wherein each adsorbent particle comprised in the hierarchical layers consists of a single adsorbent crystal or a single amorphous solid.

8: The adsorbent agglomerate of claim 1, wherein the adsorbent agglomerate is a zeolite adsorbent.

9: An adsorber comprising an adsorbent bed, said bed comprising a plurality of adsorbent agglomerates of claim 1.

10: The process for adsorptive separation of a gas mixture, using an adsorbent agglomerate of claim 1.

11: The process for adsorptive separation of a gas mixture, using an adsorber of claim 9.

12: The separation process of claim 1, wherein the process is an air separation process.

13: The use of an adsorbent agglomerate of claim 1 in processes for fractionating “n” and “iso” paraffins, fractionating xylenes, alcohols, in processes for purging hydrogen or helium.

14: The use of an adsorber of claim 9 in processes for fractionating “n” and “iso” paraffins, fractionating xylenes, alcohols, in processes for purging hydrogen or helium.

15: A process for manufacturing an adsorbent agglomerate, comprising the following steps:
supplying a plurality of adsorbent particles, each of the adsorbent particles having a volume termed particle volume,
forming at least two batches of adsorbent particles, each batch of adsorbent particles corresponding to a targeted average particle volume of the particles constituting it, a standard deviation of the particle volume values of the adsorbent particles of each batch being less than 20% relative to the targeted average particle volume of said batch,
an agglomeration step comprising the sub-steps of:
a) agglomerating adsorbent particles of a first batch into a first layer of adsorbent particles,
b) agglomerating adsorbent particles of the following batch into a following upper layer of adsorbent particles, covering the first layer of adsorbent particles,
the targeted average particle volume of each of the batches preceding a following batch being less than the targeted average particle volume of said following batch.

16: The manufacturing process of claim 13, wherein the agglomeration step is carried out by fluidization or by turntable.
